(19) United States
(12) Patent Application Publication
(10) Pub. No.: US 2026/0120673 A1
(43) Pub. Date: Apr. 30, 2026

(54) VOICE PROCESSING SYSTEM, VOICE PROCESSING METHOD, AND RECORDING MEDIUM RECORDING VOICE PROCESSING PROGRAM

(71) Applicant: SHARP KABUSHIKI KAISHA, Sakai City (JP)

(72) Inventors: Yoshio IWAI, Sakai City (JP); Koichi SUGIYAMA, Sakai City (JP)

(21) Appl. No.: 19/181,593

(22) Filed: Apr. 17, 2025

(30) Foreign Application Priority Data
May 14, 2024 (JP) 2024-078531

(51) Int. Cl. G10L 13/033; G10L 21/0208

(52) U.S. Cl. CPC G10L 13/033; G10L 21/0208

(57) ABSTRACT

In a voice processing device, an acquisition processing unit acquires a plurality of pieces of voice data corresponding to an utterance voice of a user from each of a plurality of user terminals. An acceptance processing unit accepts an adjustment request for first voice data of the plurality of pieces of voice data acquired by the acquisition processing unit. The adjustment processing unit executes voice adjustment processing on the first voice data in response to the adjustment request. An output processing unit causes a first user terminal that is a request source of the adjustment request to output adjusted voice data on which the voice adjustment processing has been executed and second voice data in which the first voice data is excluded from the plurality of pieces of voice data, and causes a second user terminal of the plurality of voice devices excluding the first user terminal to output the plurality of pieces of voice data.

### INCORPORATION BY REFERENCE

This application is based upon and claims the benefit of priority from the corresponding Japanese Patent Application No. 2024-078531 filed on May 14, 2024, the entire contents of which are incorporated herein by reference.

### BACKGROUND

The present disclosure relates to a technique of controlling voices when a plurality of users have conversations individually using voice devices.

There is a known system that enables each of a plurality of users to have conversations using a voice device including a microphone and a speaker. There is a known technique of automatically adjusting a volume level of a voice for each speaker in the conversations.

However, with the known technology, for example, when it is difficult to hear only the voice of a specific user, an attempt to adjust the volume of the user changes also the volume of other users. As described above, with the known technique, it is difficult to output an appropriate voice for each user.

### SUMMARY

An object of the present disclosure is to provide a voice processing system, a voice processing method, and a voice processing program that can output an appropriate voice for each user of a voice device.

A voice processing system according to one aspect of the present disclosure includes an acquisition processing unit, an acceptance processing unit, an adjustment processing unit, and an output processing unit. The acquisition processing unit acquires a plurality of pieces of voice data corresponding to an utterance voice of a user from each of a plurality of voice devices. The acceptance processing unit accepts an adjustment request for first voice data of the plurality of pieces of voice data acquired by the acquisition processing unit. The adjustment processing unit executes voice adjustment processing on the first voice data in response to the adjustment request. The output processing unit causes a first voice device that is a request source of the adjustment request to output adjusted voice data on which the voice adjustment processing has been executed and second voice data in which the first voice data is excluded from the plurality of pieces of voice data, and causes a second voice device of the plurality of voice devices excluding the first voice device to output the plurality of pieces of voice data.

A voice processing method according to another aspect of the present disclosure is voice processing method executed by one or more processors, the voice processing method including: acquiring a plurality of pieces of voice data corresponding to an utterance voice of a user from each of a plurality of voice devices; accepting an adjustment request for first voice data of the plurality of pieces of voice data; executing voice adjustment processing on the first voice data in response to the adjustment request; and causing a first voice device that is a request source of the adjustment request to output adjusted voice data on which the voice adjustment processing has been executed and second voice data in which the first voice data is excluded from the plurality of pieces of voice data, and causing a second voice device of the plurality of voice devices excluding the first voice device to output the plurality of pieces of voice data.

A recording medium according to another aspect of the present disclosure is a recording medium recording a voice processing program to cause one or more processors to execute: acquiring a plurality of pieces of voice data corresponding to an utterance voice of a user from each of a plurality of voice devices; accepting an adjustment request for first voice data of the plurality of pieces of voice data; executing voice adjustment processing on the first voice data in response to the adjustment request; and causing a first voice device that is a request source of the adjustment request to output adjusted voice data on which the voice adjustment processing has been executed and second voice data in which the first voice data is excluded from the plurality of pieces of voice data, and causing a second voice device of the plurality of voice devices excluding the first voice device to output the plurality of pieces of voice data.

According to the present disclosure, it is possible to provide a voice processing system and a voice processing method that can output an appropriate voice for each user of a voice device, and a recording medium recording a voice processing program that can output an appropriate voice for each user of a voice device.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a view illustrating an application example of a voice processing system according to an embodiment of the present disclosure.

FIG. 2 is a block diagram illustrating a configuration of the voice processing system according to the embodiment of the present disclosure.

FIG. 3 is a view illustrating a specific example of voice processing of the voice processing system according to the embodiment of the present disclosure.

FIG. 4 is a view illustrating a specific example of voice processing of the voice processing system according to the embodiment of the present disclosure.

FIG. 5 is a view illustrating a specific example of voice processing of the voice processing system according to the embodiment of the present disclosure.

FIG. 6 is a view illustrating a specific example of voice processing of the voice processing system according to the embodiment of the present disclosure.

FIG. 7 is a flowchart for describing an example of a procedure of voice control processing executed in the voice processing device according to the embodiment of the present disclosure.

FIG. 8 is a view illustrating a specific example of voice processing of the voice processing system according to Modification 1 of the present disclosure.

FIG. 9 is a flowchart for describing an example of a procedure of voice control processing executed in the voice processing device according to Modification 1 of the present disclosure.

FIG. 10 is a view illustrating a specific example of voice processing of the voice processing system according to Modification 2 of the present disclosure.

FIG. 11 is a flowchart for describing an example of a procedure of voice control processing executed in the voice processing device according to Modification 2 of the present disclosure.

### DETAILED DESCRIPTION

Embodiments of the present disclosure will be described below with reference to the accompanying drawings. Note that the following embodiments are specific examples of the present disclosure, and do not limit the technical scope of the present disclosure.

The voice processing system according to the present disclosure can be applied to a web meeting (online meeting) in which, for example, a plurality of users have conversations (meeting) using user terminals (example of the voice device of the present disclosure) such as laptop computers and smartphones while being at different places (meeting room of office, home, and the like). The voice processing system can execute an online meeting by a conversation application, which is general-purpose software for executing the online meeting.

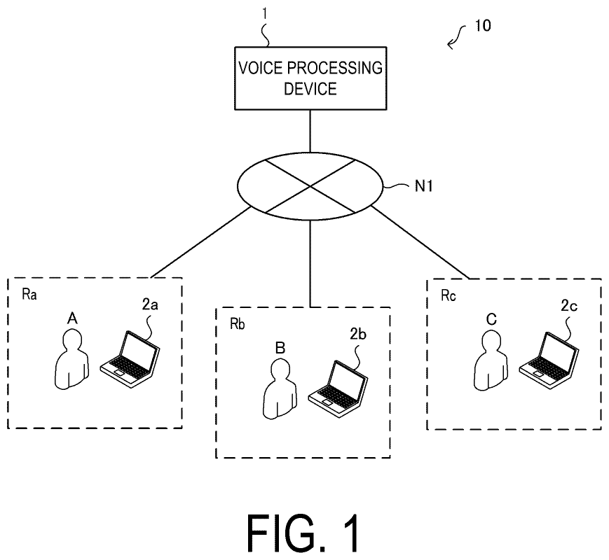

FIG. 1 illustrates an application example of a voice processing system 10 according to the present embodiment. As illustrated in FIG. 1, a user A participates in a meeting from a meeting room Ra, a user B participates in the meeting from a meeting room Rb, and a user C participates in the meeting from a meeting room Rc. The users A, B, and C have conversations using user terminals 2a, 2b, and 2c, respectively. As another embodiment, each user may have conversations using a microphone speaker device. For example, each user may use a neck band-type microphone speaker device that can be worn on the neck or a stationary microphone speaker device installed in the meeting room. The user terminal 2 and the microphone speaker device are examples of the voice device of the present disclosure.

By executing the conversation application installed in each user terminal 2, the voice processing system 10 enables a plurality of users to have an online meeting at remote locations. The conversation application is general-purpose software, and a plurality of users participating in the same meeting select the conversation application that is common.

For example, the users A, B, and C activate the conversation applications in the own user terminals 2a, 2b, and 2c, respectively.

Note that the voice processing system 10 may have a configuration in which a camera connectable to the user terminal 2 is connected to each site (meeting room, home, and the like), and camera videos can be bidirectionally communicated. The camera may be built in the user terminal 2.

A voice processing device 1 and the user terminal 2 are connected to each other via a network N1. The network N1 is a communication network such as the Internet, a LAN, a WAN, or a public telephone line.

### User Terminal 2

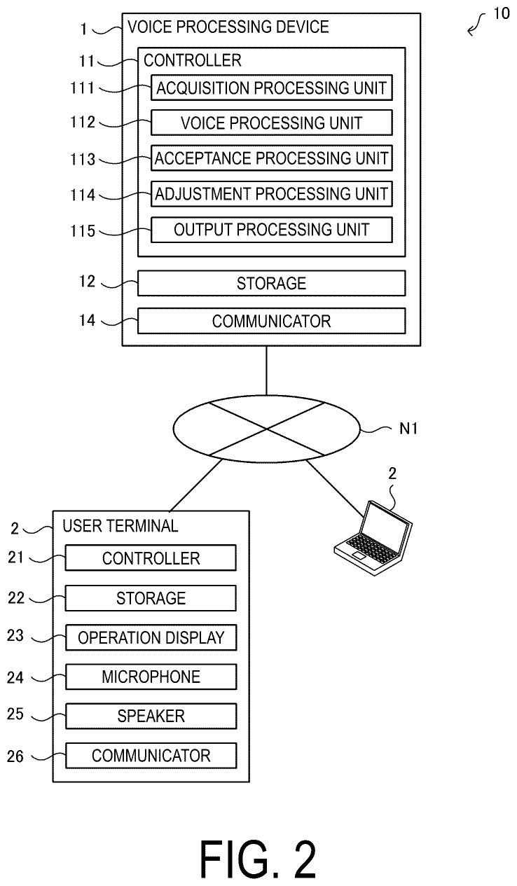

As illustrated in FIG. 2, the user terminal 2 includes a controller 21, a storage 22, an operation display 23, a microphone 24, a speaker 25, and communicator 26. The user terminal 2 is an information processing device such as a laptop computer, a smartphone, or a tablet terminal. Each user terminal 2 may have the same configuration.

The communicator 26 is a communicator that connects the user terminal 2 to the network N1 in a wired or wireless manner and executes data communication according to a predetermined communication protocol with other equipment (e.g., the voice processing device 1) via the network N1.

The microphone 24 collects an utterance voice of the user. The speaker 25 reproduces the voice output from the voice processing device 1. The microphone 24 and the speaker 25 may be integrally configured. The microphone 24 and the speaker 25 may be built in the user terminal 2, or may be externally disposed and connected to the user terminal 2 in a wired or wireless manner.

The operation display 23 is a user interface including a display such as a liquid crystal display or an organic EL display that displays various types of information, and an operation unit such as a mouse, a keyboard, or a touch panel that accepts an operation. The operation display 23 accepts a user's operation.

The storage 22 is a nonvolatile storage such as a hard disk drive (HDD), a solid state drive (SSD), or a flash memory that stores various types of information. The storage 22 stores a control program to cause the controller 21 to execute various types of processing. For example, the control program is non-transitorily recorded in a computer-readable recording medium such as a CD or a DVD, read by a reading device (not illustrated) such as a CD drive or a DVD drive included in the user terminal 2, and stored in the storage 22. The control program may be distributed from a cloud server and stored in the storage 22.

One or more conversation applications for providing an online meeting service are installed in the storage 22.

The controller 21 includes control equipment such as a CPU, a ROM, and a RAM. The CPU is a processor that executes various types of arithmetic processing. The ROM stores in advance control programs such as a BIOS and an OS to cause the CPU to execute various types of processing. The RAM stores various types of information and is used as a temporary storage memory (work area) for the various types of processing executed by the CPU. Then, the controller 21 controls the user terminal 2 by executing, by the CPU, various control programs stored in advance in the ROM or the storage 22. The controller 21 functions as a processing unit that executes the conversation application.

The controller 21 includes various types of processing units. Note that the controller 21 functions as the various types of processing units by executing various types of processing according to the control program by the CPU. Some or all of the processing units included in the controller 21 may be constituted by an electronic circuit. Note that the control program may be a program to cause a plurality of processors to function as the various types of processing units.

For example, the controller 21 executes various types of processing related to the online meeting according to the conversation application. Specifically, upon accepting an operation (login operation) of activating the conversation application by the user, the controller 21 transmits a start request to the voice processing device 1. When the voice processing device 1 authenticates the start request, the controller 21 causes the user terminal 2 to display a conversation screen and starts the online meeting.

When the online meeting is started, the controller 21 of the user terminal 2a of the user A, for example, outputs, to the voice processing device 1, the voice data of the utterance voice of the user A input to the microphone 24 of the user terminal 2a. Upon acquiring the voice data in which voices of the users output from the voice processing device 1 are synthesized, the controller 21 of the user terminal 2a reproduces the voice from the speaker 25.

The controller 21 accepts various types of operations from the user. For example, when the user finds it difficult to hear the voice of the conversation partner and makes an adjustment request for the voice, the controller 21 accepts the operation of the adjustment request. For example, in a case where the users A, B, and C are having a conversation, when the user B finds it difficult to hear only the voice of the user C because it is too quiet, the user B inputs an adjustment request for the voice of the user C to the user terminal 2b. For example, the user B make an adjustment request (volume increase request) by selecting a target user (here, the user C) for the adjustment request on the conversation screen and pressing an adjustment request button or the like. By this, the controller 21 of the user terminal 2b accepts the adjustment request for the voice of the user C. Upon accepting the adjustment request, the controller 21 outputs the adjustment request to the voice processing device 1. The voice processing device 1 executes voice adjustment processing on the voice data based on the adjustment request. The controller 21 reproduces the voice of the adjusted voice data on which the voice adjustment processing has been executed. A specific example of the voice adjustment processing will be described below.

Upon accepting an operation (end operation) to end the conversation application by the user, the controller 21 transmits an end request to the voice processing device 1. When the voice processing device 1 authenticates the end request, the controller 21 causes the user terminal 2 to end the online meeting.

Each of the users participating in the online meeting activates the conversation application in the own user terminal 2 to start the online meeting. Each user ends the conversation application in the own user terminal 2 and ends the online meeting.

### Voice Processing Device 1

As illustrated in FIG. 2, the voice processing device 1 is an information processing device including a controller 11, a storage 12, and a communicator 14. The voice processing device 1 may include, for example, one or more servers (e.g., cloud servers).

The communicator 14 is a communicator to connect the voice processing device 1 to the network N1 and execute data communication according to a predetermined communication protocol with external equipment such as the user terminal 2 via the network N1.

The storage 12 is a nonvolatile storage such as a hard disk drive (HDD), a solid state drive (SSD), or a flash memory that stores various types of information. Specifically, the storage 12 may store data such as information (equipment number, equipment ID, and the like) that enables the user terminal 2 to be identified.

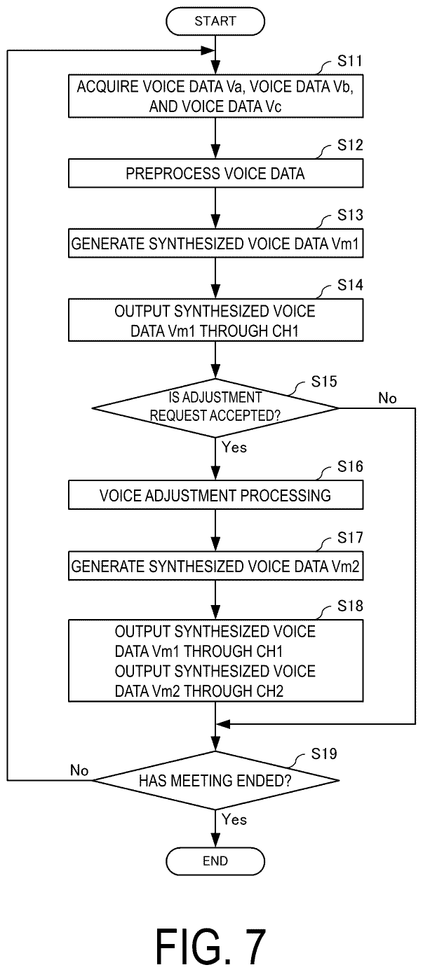

The storage 12 stores a control program such as a voice control program (example of a voice processing program of the present disclosure) to cause the controller 11 to execute voice control processing (see FIGS. 7, 9, and 11) described below. For example, the voice control program may be non-transitorily recorded in a computer-readable recording medium such as a CD or a DVD, read by a reading device (not illustrated) such as a CD drive or a DVD drive included in the voice processing device 1, and stored in the storage 12.

The controller 11 includes control equipment such as a CPU, a ROM, and a RAM. The CPU is a processor that executes various types of arithmetic processing. The ROM is nonvolatile storage that stores in advance control programs such as a BIOS and an OS to cause the CPU to execute various types of arithmetic processing. The RAM is a volatile or nonvolatile storage that stores various types of information and is used as a temporary storage memory (work area) for the various types of processing executed by the CPU. Then, the controller 11 controls the voice processing device 1 by executing, by the CPU, various control programs stored in advance in the ROM or the storage 12.

Specifically, as illustrated in FIG. 2, the controller 11 includes various types of processing units such as an acquisition processing unit 111, a voice processing unit 112, an acceptance processing unit 113, an adjustment processing unit 114, and an output processing unit 115. Note that the controller 11 functions as the various types of processing units by executing various types of processing according to the control program by the CPU. Some or all of the processing units may be constituted by an electronic circuit. Note that the control program may be a program to cause a plurality of processors to function as the processing unit.

The acquisition processing unit 111 acquires a plurality of pieces of voice data corresponding to an utterance voice of a user from each of the plurality of user terminals 2. For example, when the online meeting is started and each user utters, the acquisition processing unit 111 acquires voice data output from each user terminal 2. The acquisition processing unit 111 assigns the acquired voice data with identification information (equipment number) of the user terminal 2 or identification information (user ID) of the user, and saves the acquired voice data into the storage 12.

The voice processing unit 112 executes predetermined voice processing on the voice data. Specifically, the voice processing unit 112 executes known voice processing (preprocessing) such as gain adjustment, noise removal, and echo cancellation on each piece of voice data.

The voice processing unit 112 executes synthesis processing of synthesizing each piece of voice data subjected to the voice processing. Specifically, the voice processing unit 112 executes processing of synthesis and encoding to generate voice data (synthesized voice data) to be output (distributed) to the user terminal 2.

The acceptance processing unit 113 accepts an adjustment request for specific voice data (first voice data of the present disclosure) of the plurality of pieces of voice data acquired by the acquisition processing unit 111. For example, in a case where the users A, B, and C are having a conversation, when the user B finds it difficult to hear only the voice of the user C because it is too quiet and inputs an adjustment request for the voice of the user C to the user terminal 2b, the acceptance processing unit 113 accepts the adjustment request for the voice of the user C from the user terminal 2b. As described above, the acceptance processing unit 113 accepts the adjustment request for the voice data in response to an adjustment request instruction for the voice data by the user of the user terminal 2.

The adjustment processing unit 114 executes voice adjustment processing on the voice data being an adjustment target in response to the adjustment request. Specifically, the adjustment processing unit 114 executes adjustment processing in response to the adjustment request, for example, volume adjustment, frequency (pitch) adjustment, speed adjustment, and the like, on the voice data being the adjustment target. For example, when the user B makes an adjustment request so as to increase the volume of the voice of the user C, the adjustment processing unit 114 increases the volume of the voice of the user C.

The output processing unit 115 outputs the voice data (synthesized voice data) after the voice processing to the user terminal 2. The output processing unit 115 outputs the voice data after voice adjustment to the user terminal 2 that is the request source of the adjustment request. The output processing unit 115 transmits the voice data to each user terminal 2 and causes each user terminal 2 to output (reproduce) the voice data.

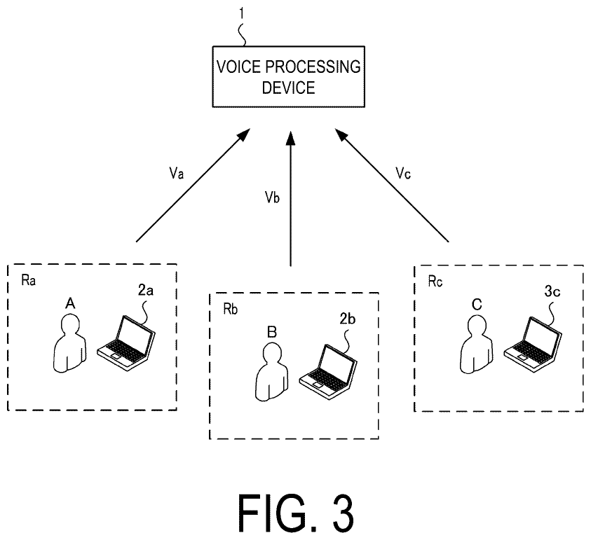

Hereinafter, specific examples of voice processing (preprocessing), voice synthesis processing, voice adjustment processing, and output processing executed in the controller 11 will be described. For example, as illustrated in FIG. 3, the controller 11 acquires voice data Va of an utterance voice of the user A from the user terminal 2a, acquires voice data Vb of an utterance voice of the user B from the user terminal 2b, and acquires voice data Vc of an utterance voice of the user C from the user terminal 2c.

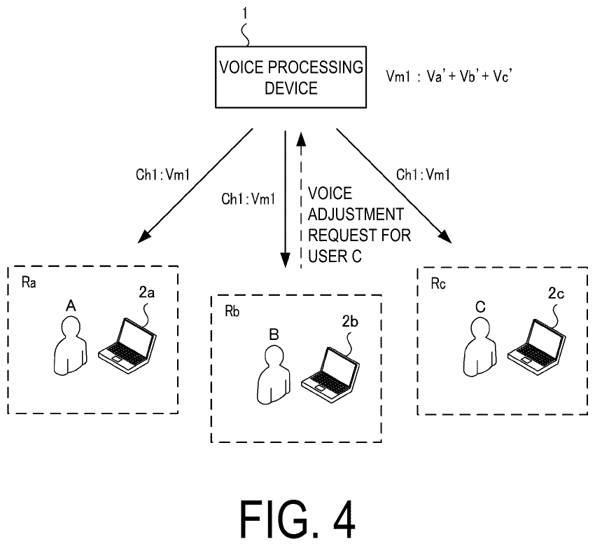

Upon acquiring the voice data Va, the voice data Vb, and the voice data Vc (see FIG. 3), the controller 11 executes known voice processing (preprocessing) such as gain adjustment, noise removal, and echo cancellation for each of the voice data Va, the voice data Vb, and the voice data Vc, and generates voice data Va′, the voice data Vb′, and the voice data Vc′ after the voice processing. Subsequently, the controller 11 executes synthesis processing of synthesizing and encoding the voice data Va′, the voice data Vb′, and the voice data Vc′ to generate synthesized voice data Vm1 (Va′+Vb′+Vc′) (see FIG. 4). Then, the controller 11 outputs (distributes) the synthesized voice data Vm1 to each of the user terminals 2a, 2b, and 2c using a channel Ch1 (example of the second channel of the present disclosure) of the voice processing device 1 (see FIG. 4).

Note that, for convenience of description, it is assumed here to output the synthesized voice data Vm1 (Va′+Vb′+Vc′) common to the user terminals 2, but in practice, the controller 11 mutes and outputs the user's own voice. For example, the controller 11 mutes the voice of the user A and transmits the synthesized voice data Vm1 (Vb′+Vc′) when transmitting to the user terminal 2a, and mutes the voice of the user B and transmits the synthesized voice data Vm1 (Va′+Vc′) when transmitting to the user terminal 2b.

Upon acquiring the synthesized voice data Vm1, each of the user terminals 2a, 2b, and 2c reproduces the voice corresponding to the synthesized voice data Vm1 from the speaker 25.

Here, for example, when the user B finds it difficult to hear (e.g., the volume is low) only the voice of the user C of the voices reproduced from the user terminal 2b, the user B makes an adjustment request so as to increase the volume of the voice of the user C (see FIG. 4). In this case, upon accepting the adjustment request from the user terminal 2b, the controller 11 executes voice adjustment processing on the voice data Vc′ of the user C according to the adjustment request. Here, the controller 11 generates voice data Vc″ (adjusted voice data) in which the volume of the voice data Vc′ is increased.

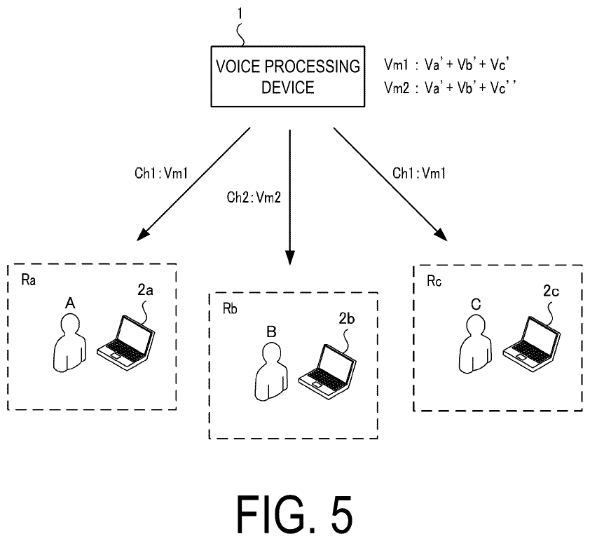

Upon executing the voice adjustment processing, the controller 11 generates synthesized voice data including the voice data on which the voice adjustment processing has been executed. For example, the controller 11 executes synthesis processing of synthesizing the voice data Va′, the voice data Vb′, and the voice data Vc″ to generate synthesized voice data Vm2 (Va′+Vb′+Vc″) (see FIG. 5). Then, the controller 11 outputs (distributes) the synthesized voice data Vm2 to the user terminal 2b of the request source of the adjustment request using a channel Ch2 (example of the first channel of the present disclosure) of the voice processing device 1 (see FIG. 5).

As described above, when the user B makes the adjustment request, the controller 11 outputs the synthesized voice data Vm1 (Va′+Vb′+Vc′) to the user terminals 2a and 2c using the channel Ch1 of the voice processing device 1, and outputs the synthesized voice data Vm2 (Va′+Vb′+Vc″) to the user terminal 2b using the channel Ch2 of the voice processing device 1 (see FIG. 5). This makes the user B easily hear the voice of the user C. The quality of the voice of the user A does not change, and therefore the user B can hear the voice of the user A and the voice of the user C with an equal quality. The user terminal 2a reproduces the voice of the user C that is a voice (voice data Vc′) having not been subjected to voice adjustment processing, and therefore the quality of the voice of the user C does not change. As described above, since an appropriate voice is output for each user, all users can easily hear the voice.

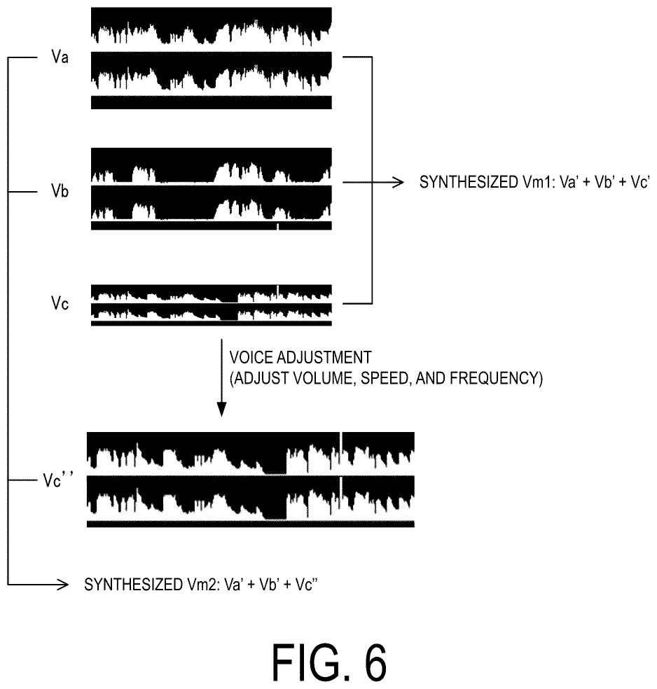

FIG. 6 illustrates an example of voice adjustment processing. The controller 11 generates the synthesized voice data Vm1 (Va′+Vb′+Vc′) based on the voice data Va, the voice data Vb, and the voice data Vc acquired from the respective user terminals 2, and executes the voice adjustment processing in response to an adjustment request (here, adjustment request for volume, speed, and frequency) to generate the synthesized voice data Vm2 (Va′+Vb′+Vc″). The voice adjustment processing includes processing such as increasing/decreasing the volume, increasing (high frequency)/decreasing (low frequency) the speed, and increasing/decreasing the pitch.

### Voice Control Processing

FIG. 7 shows an example of the procedure of voice control processing executed by the controller 11 of the voice processing device 1.

Note that the present disclosure can be understood as a voice control method (voice processing method of the present disclosure) to execute one or more steps included in the voice control processing. One or more steps included in the voice control processing described here may be appropriately omitted. The execution order of the steps in the voice control processing may be different in a range where similar actions and effects are produced. Furthermore, here, a case where the controller 11 executes each step in the voice control processing will be described as an example, but in another embodiment, one or more processors may dispersedly execute each step in the voice control processing.

Here, as illustrated in FIG. 1, a case where the users A, B, and C have a meeting using the user terminals 2a, 2b, and 2c will be described as an example.

### Step S11

First, in step S11, the controller 11 acquires voice data from the user terminal 2. Here, the controller 11 acquires the voice data Va of the utterance voice of the user A from the user terminal 2a, acquires the voice data Vb of the utterance voice of the user B from the user terminal 2b, and acquires the voice data Vc of the utterance voice of the user C from the user terminal 2c (see FIG. 3).

### Step S12

Next, in step S12, the controller 11 executes predetermined voice processing (preprocessing) on the acquired voice data. For example, the controller 11 executes voice processing such as gain adjustment, noise removal, and echo cancellation on the voice data Va, the voice data Vb, and the voice data Vc. The voice data after the voice processing is represented as the voice data Va′, the voice data Vb′, and the voice data Vc′.

### Step S13

Next, in step S13, the controller 11 generates the synthesized voice data. Specifically, the controller 11 generates the synthesized voice data Vm1 in which the voice data Va′, the voice data Vb′, and the voice data Vc′ after the voice processing are synthesized (see FIG. 4).

### Step S14

In step S14, the controller 11 outputs the synthesized voice data Vm1 (Va′+Vb′+Vc′) to the user terminals 2a, 2b, and 2c using the channel Ch1 of the voice processing device 1 (see FIG. 4). Each of the user terminals 2a, 2b, and 2c reproduces the voice of the synthesized voice data Vm1 (Va′+Vb′+Vc′).

### Step S15

Next, in step S15, the controller 11 determines whether the adjustment request for the voice has been accepted from the user terminal 2. Upon accepting the adjustment request for the voice from the user terminal 2 (S15: Yes), the controller 11 transitions the processing to step S16. On the other hand, upon not accepting the adjustment request for the voice from the user terminal 2 (S15: No), the controller 11 transitions the processing to step S19.

For example, when the user B finds it difficult to hear (e.g., the volume is low) only the voice of the user C of the voices reproduced from the user terminal 2b, the user B makes an adjustment request so as to increase the volume of the voice of the user C (see FIG. 4). In this case, the controller 11 accepts the adjustment request for the voice of the user C from the user terminal 2b, and transitions the processing to step S16.

### Step S16

In step S16, the controller 11 executes the voice adjustment processing. Here, the controller 11 executes the voice adjustment processing on the voice data Vc′ of the user C according to the adjustment request accepted from the user terminal 2b. For example, the controller 11 generates the voice data Vc″ (adjusted voice data) in which the volume of the voice data Vc′ is increased (see FIG. 5).

### Step S17

In step S17, the controller 11 generates the synthesized voice data. Specifically, the controller 11 generates the synthesized voice data Vm2 (Va′+Vb′+Vc″) in which the voice data Va′ and the voice data Vb′ after the voice processing and the voice data Vc″ after the voice adjustment processing are synthesized (see FIG. 5).

### Step S18

In step S18, the controller 11 outputs the generated synthesized voice data to the user terminal 2. Specifically, the controller 11 outputs the synthesized voice data Vm1 (Va′+Vb′+Vc′) to the user terminals 2a and 2c using the channel Ch1 of the voice processing device 1, and outputs the synthesized voice data Vm2 (Va′+Vb′+Vc″) to the user terminal 2b using the channel Ch2 of the voice processing device 1 (see FIG. 5).

The user terminals 2a and 2c reproduce the voice of the synthesized voice data Vm1 (Va′+Vb′+Vc′), and the user terminal 2b reproduces the voice of the synthesized voice data Vm2 (Va′+Vb′+Vc″).

### Step S19

In step S19, the controller 11 determines whether the meeting has ended. For example, if the user performs a meeting end operation on the user terminal 2, the controller 11 determines that the meeting has ended (S19: Yes), and ends the voice control processing. If determining that the meeting has not ended (S19: No), the controller 11 returns the processing to step S11. The controller 11 repeatedly executes the above-described processing until the meeting ends.

As described above, when the user makes an adjustment request, the controller 11 outputs, using the channel Ch1 of the voice processing device 1, the synthesized voice data Vm1 (Va′+Vb′+Vc′) to the user terminals 2 of the users other than the user who has made the adjustment request, and outputs, using the channel Ch2 of the voice processing device 1, the synthesized voice data Vm2 (Va′+Vb′+Vc″) to the user terminal 2 of the user who has made the adjustment request.

### Modification 1

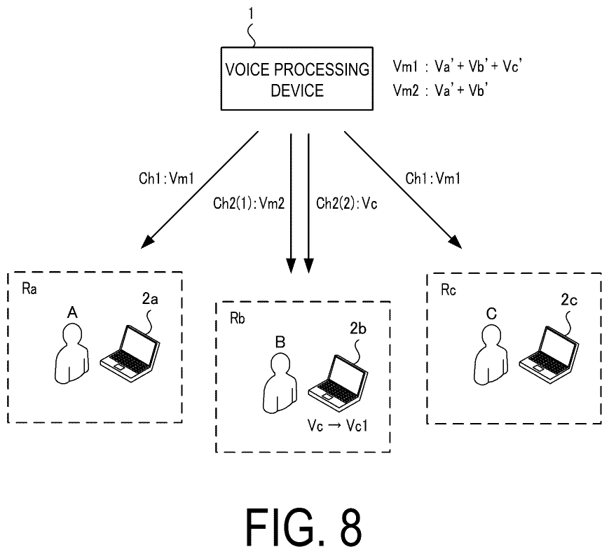

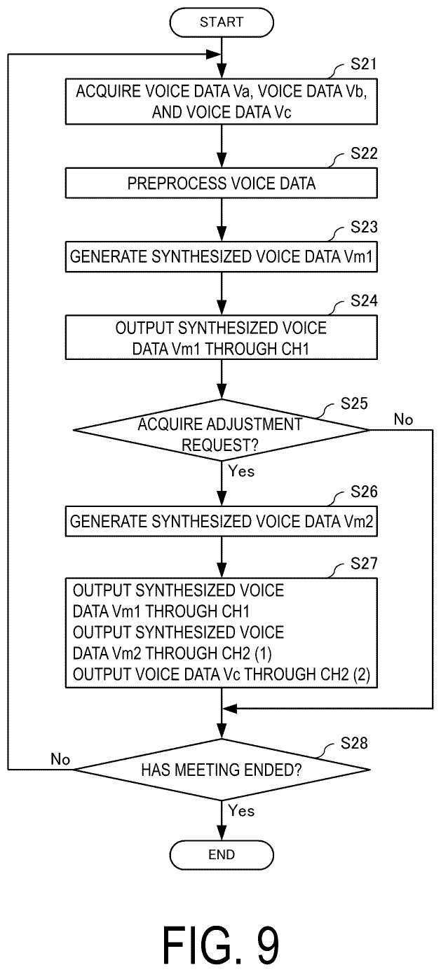

Modification 1 of the present embodiment will be described with reference to FIGS. 8 and 9. In Modification 1, for example, when the user B makes an adjustment request for the voice of the user C (see FIG. 4), the controller 11 generates synthesized voice data Vm2 (Va′+Vb′) in which the voice data Va and the voice data Vb after the voice processing (preprocessing) are synthesized based on the voice other than the voice of the user C (voices of the users A and B) (see FIG. 8). Then, the controller 11 outputs (distributes) the synthesized voice data Vm2 to the user terminal 2b of the request source of the adjustment request using a channel Ch2 (1) of the voice processing device 1, and outputs (distributes) the original voice (voice data before voice processing) of the voice data Vc of the user C using a channel Ch2 (2) of the voice processing device 1 (see FIG. 8).

In this case, upon acquiring the voice data Vc, the controller 21 of the user terminal 2b executes voice adjustment processing on the voice data Vc. For example, the controller 21 executes processing of adjusting the volume, speed, pitch, and the like of the voice data Vc in response to the adjustment request for the user B to generate voice data Vc1. Then, the controller 21 simultaneously reproduces the voice of the synthesized voice data Vm2 (Va′+Vb′) and the voice of the voice data Vc1 after the voice adjustment. Note that the controller 21 may resynthesize and reproduce the voice of the synthesized voice data Vm2 (Va′+Vb′) and the voice of the voice data Vc1.

Note that the user terminals 2a and 2c acquire the synthesized voice data Vm1 (Va′+Vb′+Vc′) distributed from the channel Ch1 of the voice processing device 1 and reproduce the voice.

FIG. 9 shows a flowchart of the voice control processing according to Modification 1. Steps S21 to S25 are the same as steps S11 to S15 shown in FIG. 7, and therefore the description thereof will be omitted. In Modification 1, the voice adjustment processing (step S16) shown in FIG. 7 is omitted.

### Step S26

In step S26, the controller 11 synthesizes the voice data Va and the voice data Vb of the voices (voices of the users A and B) excluding the voice being the adjustment target (voice of the user C) to generate the synthesized voice data Vm2 (Va′+Vb′) (see FIG. 8).

### Step S27

In step S27, the controller 11 outputs the synthesized voice data Vm1 (Va′+Vb′+Vc′) to the user terminals 2a and 2c using the channel Ch1 of the voice processing device 1, outputs the synthesized voice data Vm2 (Va′+Vb′) to the user terminal 2b using the channel Ch2 (1) of the voice processing device 1, and outputs the voice data Vc (original voice) being the adjustment target to the user terminal 2b using the channel Ch2 (2) of the voice processing device 1 (see FIG. 8).

The user terminals 2a and 2c reproduce the voice of the synthesized voice data Vm1 (Va′+Vb′+Vc′). The user terminal 2b executes the voice adjustment processing in response to the adjustment request on the voice data Vc being the adjustment target to generate the adjusted voice data Vc1. Then, the user terminal 2b simultaneously reproduces the voice of the synthesized voice data Vm2 (Va′+Vb′) and the voice of the voice data Vc1.

As described above, in Modification 1, the controller 11 of the voice processing device 1 outputs the voice data (original voice) of the voice being the adjustment target and the remaining voice data (synthesized voice data) excluding the voice data being the adjustment target of the plurality of pieces of voice data to the user terminal 2 that is an adjustment request source using the channels Ch2 (1) and Ch2 (2), and outputs the synthesized voice data in which the plurality of pieces of voice data are synthesized to the other user terminals 2 using the channel Ch1. That is, in Modification 1, the voice processing device 1 outputs the voice being the adjustment target to the user terminal 2 without executing the voice adjustment processing, and the user terminal 2 executes the voice adjustment processing. For example, the controller 21 of the user terminal 2 executes the voice adjustment processing on the voice data before executing the voice processing including gain adjustment and noise removal. In Modification 1, the controller 21 of the user terminal 2 may function as the adjustment processing unit and the output processing unit of the present disclosure.

### Modification 2

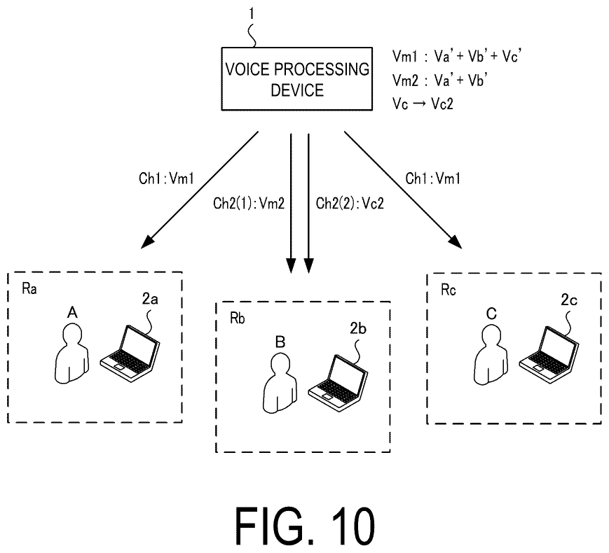

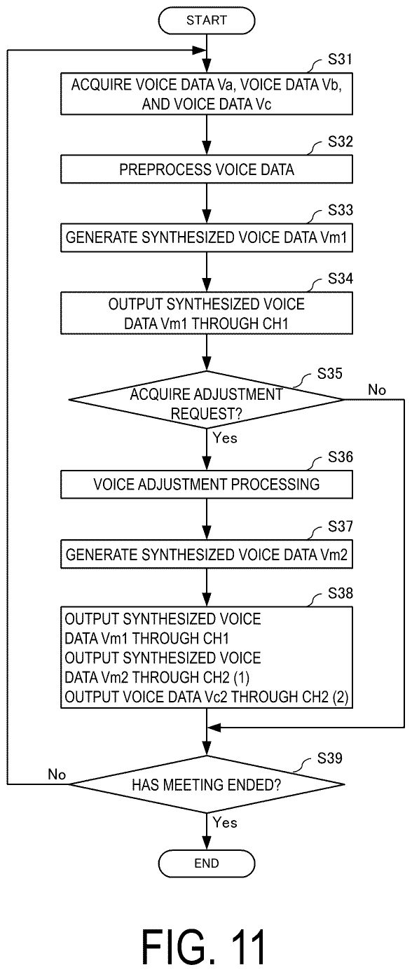

Modification 2 of the present embodiment will be described with reference to FIGS. 10 and 11. In Modification 2, for example, when the user B makes an adjustment request (see FIG. 4), the controller 11 generates the synthesized voice data Vm2 (Va′+Vb′) in which the voice data Va and the voice data Vb after the voice processing (preprocessing) are synthesized and the voice data Vc2 the voice processing (preprocessing) and the voice adjustment processing are executed on the voice data Vc being the adjustment target (see FIG. 10). For example, the controller 11 executes processing of adjusting the volume, speed, pitch, and the like of the voice data Vc in response to the adjustment request for the user B to generate the voice data Vc2.

Then, the controller 11 outputs (distributes) the synthesized voice data Vm2 to the user terminal 2b of the request source of the adjustment request using a channel Ch2 (1) of the voice processing device 1, and outputs (distributes) the voice data Vc2 after the voice adjustment using the channel Ch2 (2) of the voice processing device 1 (see FIG. 10).

The user terminal 2b acquires the synthesized voice data Vm2 (Va′+Vb′) distributed from the channel Ch2 (1) of the voice processing device 1 and the voice data Vc2 distributed from the channel Ch2 (2) of the voice processing device 1, and simultaneously reproduces the voices of the respective voice data. The user terminals 2a and 2c acquire the synthesized voice data Vm1 (Va′+Vb′+Vc′) distributed from the channel Ch1 of the voice processing device 1 and reproduce the voice.

FIG. 11 shows a flowchart of the voice control processing according to Modification 2. Steps S31 to S36 are the same as steps S11 to S16 shown in FIG. 7, and therefore the description thereof will be omitted. Note that in step S36, the controller 11 executes the voice adjustment processing on the voice data Vc′ of the user C according to the adjustment request accepted from the user terminal 2b. For example, the controller 11 generates the voice data Vc2 (adjusted voice data) in which the volume of the voice data Vc′ is increased (see FIG. 10).

### Step S37

In step S37, the controller 11 synthesizes the voice data Va and the voice data Vb of the voices (voices of the users A and B) excluding the voice being the adjustment target (voice of the user C) to generate the synthesized voice data Vm2 (Va′+Vb′) (see FIG. 10).

### Step S38

In step S38, the controller 11 outputs the synthesized voice data Vm1 (Va′+Vb′+Vc′) to the user terminals 2a and 2c using the channel Ch1 of the voice processing device 1, outputs the synthesized voice data Vm2 (Va′+Vb′) to the user terminal 2b using the channel Ch2 (1) of the voice processing device 1, and outputs the voice data Vc2 subjected to the voice adjustment processing to the user terminal 2b using the channel Ch2 (2) of the voice processing device 1 (see FIG. 10).

The user terminals 2a and 2c reproduce the voice of the synthesized voice data Vm1 (Va′+Vb′+Vc′). The user terminal 2b simultaneously reproduces the voice of the synthesized voice data Vm2 (Va′+Vb′) and the voice of the voice data Vc2.

As described above, in Modification 2, the controller 11 of the voice processing device 1 outputs the voice data (adjusted voice data) of the voice being the adjustment target and the remaining voice data (synthesized voice data) excluding the voice data being the adjustment target of the plurality of pieces of voice data to the user terminal 2 that is the adjustment request source using the channels Ch2 (1) and Ch2 (2), and outputs the synthesized voice data in which the plurality of pieces of voice data are synthesized to the other user terminals 2 using the channel Ch1. That is, in Modification 2, the voice processing device 1 executes the voice adjustment processing on the voice being the adjustment target, and separately outputs the voice data after the adjustment processing and the synthesized voice data of the other voices to the user terminal 2 of the adjustment request source. In Modification 2, the controller 21 of the user terminal 2 may function as the output processing unit of the present disclosure.

As described in each embodiment described above, the voice processing system 10 according to the present disclosure acquires a plurality of pieces of voice data corresponding to utterance voices of users from each of the plurality of user terminals 2 (voice devices), and accepts an adjustment request for specific voice data (first voice data) of the plurality of pieces of voice data that are acquired. The voice processing system 10 executes the voice adjustment processing on the first voice data in response to the adjustment request, causes the first user terminal 2 (first voice device), which is a request source of the adjustment request, to output (reproduce) the adjusted voice data on which the voice adjustment processing has been executed and the second voice data excluding the first voice data from the plurality of pieces of voice data, and causes the second user terminal 2 the plurality of user terminals 2 excluding the first user terminal 2 to output the plurality of pieces of voice data.

For example, the voice processing system 10 outputs, to the first user terminal 2, the synthesized voice data Vm2 in which the adjusted voice data and the second voice data are synthesized, and outputs, to the second user terminal 2, the synthesized voice data Vm1 in which the plurality of pieces of voice data are synthesized (see FIG. 5). For example, the voice processing system 10 outputs the synthesized voice data Vm1 to the first user terminal 2 through the channel Ch1, and outputs the synthesized voice data Vm2 to the second user terminal 2 through the channel Ch2.

For example, the voice processing system 10 outputs the first voice data being the adjustment target (e.g., the original voice of the voice data Vc) and the second voice data (e.g., the synthesized voice data Vm2 of the voice data Va and the voice data Vb) to the first user terminal 2 through the channel Ch2 (e.g., channels Ch2 (1) and Ch2 (2)), and outputs the synthesized voice data Vm1 in which the plurality of pieces of voice data are synthesized to the second user terminal 2 through the channel Ch1 (see FIG. 8).

For example, the voice processing system 10 outputs the adjusted voice data (e.g., the voice data Vc2 in which the voice data Vc has been subjected to the voice adjustment processing) subjected to the voice adjustment processing and the second voice data (e.g., the synthesized voice data Vm2 of the voice data Va and the voice data Vb) to the first user terminal 2 through the channel Ch2 (e.g., channels Ch2 (1) and Ch2 (2)), and outputs the synthesized voice data Vm1 in which the plurality of pieces of voice data are synthesized to the second user terminal 2 through the channel Ch1 (see FIG. 10).

The voice processing system 10 according to the present embodiment may have a translation function that translates a voice in a first language received from the user terminal 2 into a second language. For example, the voice processing device 1 acquires Japanese voice data Va and the voice data Vb from the user terminals 2a and 2b, and acquires English voice data Vc from the user terminal 2c. When the user B makes an adjustment request (translation request), the voice processing device 1 outputs (distributes), using the channel Ch2 (1), the synthesized voice data Vm2 (Va′+Vb′) in which the voice data Va and the voice data Vb are synthesized to the user terminal 2b that is the request source of the adjustment request, and outputs (distributes), using the channel Ch2 (2), the voice data Vc (original voice) (see FIG. 8) or the voice data Vc2 (see FIG. 10) after the voice adjustment. The user terminal 2b translates the voice data Vc or Vc2 from English into Japanese. As described above, when different languages are included, the voice processing device 1 can improve the translation accuracy by distributing the voice data to the user terminal 2 using different channels for respective languages.

Note that the translation processing may be executed by the voice processing device 1. For example, upon acquiring the Japanese voice data Va and the voice data Vb from the user terminals 2a and 2b and acquiring the English voice data Vc from the user terminal 2c, the voice processing device 1 translates voice data Vc from English into Japanese. Then, the voice processing device 1 outputs (distributes), using the channel Ch2 (1), the synthesized voice data Vm2 (Va′+Vb′) to the user terminal 2b, and outputs (distributes), using channel Ch2 (2), translation voice data after translation.

The voice processing system 10 according to the present embodiment may have a text conversion function (transcription function) that converts voice data into text. For example, upon acquiring the voice data Va, the voice data Vb, and the voice data Vc from the user terminals 2a, 2b, and 2c, and accepting the adjustment request for the voice of the user C from the user B, the voice processing device 1 outputs (distributes) the synthesized voice data Vm2 (Va′+Vb′) in which the voice data Va and the voice data Vb are synthesized to the user terminal 2b using the channel Ch2 (1), and performs text conversion on the voice data Vc (original voice) (see FIG. 8) or the voice data Vc2 after the voice adjustment (see FIG. 10) with the synthesized voice data Vm2 and the voice data Vc or the voice data Vc2 after the voice adjustment separated. This can improve the text conversion accuracy.

Note that the text conversion processing may be executed by the voice processing device 1. For example, upon acquiring the voice data Va, the voice data Vb, and the voice data Vc from the user terminals 2a, 2b, and 2c, the voice processing device 1 performs text conversion on the synthesized voice data Vm2 (Va′+Vb′), and executes the text conversion processing after executing the voice adjustment processing on the voice data Vc being the adjustment target. Then, the voice processing device 1 outputs text information corresponding to the synthesized voice data Vm2 and the voice data Vc to the user terminal 2b. That is, the adjustment processing unit 114 of the present disclosure may execute at least any of volume adjustment, frequency adjustment, speed adjustment, translation, and text conversion.

In each embodiment described above, the user terminal 2 outputs the adjustment request to the voice processing device 1 when accepting the adjustment request from the user. As another embodiment, the user terminal 2 may analyze voice data acquired from the voice processing device 1, determine whether voice adjustment processing needs to be executed, and output an adjustment request instruction to the voice processing device 1 when determining that the voice adjustment processing needs to be executed. The controller 11 of the voice processing device 1 may accept an adjustment request for voice data when the user terminal 2 analyzes a plurality of pieces of voice data and outputs an adjustment request instruction for the voice data. For example, the user terminal 2 compares volumes, frequencies, speeds, and the like of a plurality of pieces of voice data, and determines whether voice adjustment processing needs to be executed. As another embodiment, the voice processing device 1 may determine whether voice adjustment processing needs to be executed based on voice data acquired from the user terminal 2.

### Supplementary Notes of Disclosure

Hereinafter, an outline of the disclosure extracted from the above-described embodiments will be described as Supplementary Notes. Note that configurations and processing functions described in the following Supplementary Notes can be selected and combined as desired.

### Supplementary Note 1

A voice processing system including:
an acquisition processing circuit that acquires a plurality of pieces of voice data corresponding to an utterance voice of a user from each of a plurality of voice devices;
an acceptance processing circuit that accepts an adjustment request for first voice data of the plurality of pieces of voice data acquired by the acquisition processing circuit;
an adjustment processing circuit that executes voice adjustment processing on the first voice data in response to the adjustment request; and
an output processing circuit that causes a first voice device that is a request source of the adjustment request to output adjusted voice data on which the voice adjustment processing has been executed and second voice data in which the first voice data is excluded from the plurality of pieces of voice data, and causes a second voice device of the plurality of voice devices excluding the first voice device to output the plurality of pieces of voice data.

### Supplementary Note 2

The voice processing system according to Supplementary Note 1, in which the acceptance processing circuit accepts an adjustment request for the first voice data in response to an adjustment request instruction for the first voice data by a user of the first voice device.

### Supplementary Note 3

The voice processing system according to Supplementary Note 1, in which the acceptance processing circuit accepts an adjustment request for the first voice data when the first voice device analyzes the plurality of pieces of voice data and outputs an adjustment request instruction for the first voice data.

### Supplementary Note 4

The voice processing system according to any of Supplementary Notes 1 to 3, in which the output processing circuit outputs, to the first voice device, first synthesized voice data in which the adjusted voice data and the second voice data are synthesized, and outputs, to the second voice device, second synthesized voice data in which the plurality of pieces of voice data are synthesized.

### Supplementary Note 5

The voice processing system according to Supplementary Note 4, in which the output processing circuit outputs the first synthesized voice data to the first voice device through a first channel and outputs the second synthesized voice data to the second voice device through a second channel.

### Supplementary Note 6

The voice processing system according to any of Supplementary Notes 1 to 5, in which the adjustment processing circuit included in the first voice device executes the voice adjustment processing on the first voice data, and the output processing circuit included in the first voice device causes the first voice device to output the adjusted voice data and the second voice data.

### Supplementary Note 7

The voice processing system according to Supplementary Note 6, in which the adjustment processing circuit included in the first voice device executes the voice adjustment processing on the first voice data before executing voice processing including gain adjustment and noise removal.

### Supplementary Note 8

The voice processing system according to any of Supplementary Notes 1 to 5, in which the output processing circuit outputs the first voice data or the adjusted voice data and the second voice data to the first voice device through a first channel, and outputs, to the second voice device through a second channel, synthesized voice data in which the plurality of pieces of voice data are synthesized.

### Supplementary Note 9

The voice processing system according to any of Supplementary Notes 1 to 8, in which the adjustment processing circuit executes at least any of volume adjustment, frequency adjustment, speed adjustment, translation, and text conversion.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A voice processing system comprising one or more processors,
wherein the one or more processors are configured to:
acquire a plurality of pieces of voice data corresponding to an utterance voice of a user from each of a plurality of voice devices;
accept an adjustment request for first voice data of the plurality of pieces of voice data;
execute voice adjustment processing on the first voice data in response to the adjustment request; and
cause a first voice device that is a request source of the adjustment request to output adjusted voice data on which the voice adjustment processing has been executed and second voice data in which the first voice data is excluded from the plurality of pieces of voice data, and cause a second voice device of the plurality of voice devices excluding the first voice device to output the plurality of pieces of voice data.

2. The voice processing system according to claim 1, wherein
the one or more processors accept an adjustment request for the first voice data in response to an adjustment request instruction for the first voice data by a user of the first voice device.

3. The voice processing system according to claim 1, wherein
the one or more processors accept an adjustment request for the first voice data when the first voice device analyzes the plurality of pieces of voice data and outputs an adjustment request instruction for the first voice data.

4. The voice processing system according to claim 1, wherein
the one or more processors output, to the first voice device, first synthesized voice data in which the adjusted voice data and the second voice data are synthesized, and output, to the second voice device, second synthesized voice data in which the plurality of pieces of voice data are synthesized.

5. The voice processing system according to claim 4, wherein
the one or more processors output the first synthesized voice data to the first voice device through a first channel and output the second synthesized voice data to the second voice device through a second channel.

6. The voice processing system according to claim 1, wherein
the first voice device includes the one or more processors, and
the one or more processors execute the voice adjustment processing on the first voice data and cause the first voice device to output the adjusted voice data and the second voice data.

7. The voice processing system according to claim 6, wherein
the first voice device includes the one or more processors, and
the one or more processors execute the voice adjustment processing on the first voice data before executing voice processing including gain adjustment and noise removal.

8. The voice processing system according to claim 1, wherein
the one or more processors output the first voice data or the adjusted voice data and the second voice data to the first voice device through a first channel, and output, to the second voice device through a second channel, synthesized voice data in which the plurality of pieces of voice data are synthesized.

9. The voice processing system according to claim 1, wherein
the one or more processors execute at least any of volume adjustment, frequency adjustment, speed adjustment, translation, and text conversion.

10. A voice processing method executed by one or more processors, wherein
the voice processing method includes:
acquiring a plurality of pieces of voice data corresponding to an utterance voice of a user from each of a plurality of voice devices;
accepting an adjustment request for first voice data of the plurality of pieces of voice data;
executing voice adjustment processing on the first voice data in response to the adjustment request; and
causing a first voice device that is a request source of the adjustment request to output adjusted voice data on which the voice adjustment processing has been executed and second voice data in which the first voice data is excluded from the plurality of pieces of voice data, and causing a second voice device of the plurality of voice devices excluding the first voice device to output the plurality of pieces of voice data.

11. A non-transitory computer-readable recording medium recording a voice processing program, wherein
the voice processing program causes one or more processors to execute:
acquiring a plurality of pieces of voice data corresponding to an utterance voice of a user from each of a plurality of voice devices;
accepting an adjustment request for first voice data of the plurality of pieces of voice data;
executing voice adjustment processing on the first voice data in response to the adjustment request; and
causing a first voice device that is a request source of the adjustment request to output adjusted voice data on which the voice adjustment processing has been executed and second voice data in which the first voice data is excluded from the plurality of pieces of voice data, and causing a second voice device of the plurality of voice devices excluding the first voice device to output the plurality of pieces of voice data.
